(19) United States
(12) Patent Application Publication
(10) Pub. No.: US 2006/0110490 A1
(43) Pub. Date: May 25, 2006

(54) Apparatus for manufacturing blind slats

(76) Inventor: Jerry Nien, Changhua Hsien (TW)

Correspondence Address: TROXELL LAW OFFICE PLLC, SUITE 1404, 5205 LEESBUG PIKE, FALLS CHURCH, VA, 22041, US

(21) Appl. No.: 11/050,839

(22) Filed: Feb. 7, 2005

(30) Foreign Application Priority Data
Nov. 24, 2004 (TW) 093218853

(51) Int. Cl. B29C 43/34

(52) U.S. Cl. 425/392

(57) ABSTRACT

An apparatus for manufacturing blind slats comprises a molding apparatus equipped with a multiplicity of upper and lower rollers to feed a finished blind slat into a heating unit so that binding sections and adhesive coating of the blind slat can be heated and softened thereby wherein at one adjacent side of the heating unit is situated a lower die having a curved convex surface defined thereon towards which the heated and softened blind slat is continuously moved along, and on top of the lower die is disposed a multiplicity of upper roller dies with curved concave surface defined thereon to roll and press onto the upper surface of the blind slat, permitting the blind slat to clamp at the matching curved convex and concave surfaces of the lower and upper dies there-between and, thus, bend into an arched form thereby. At the other side of the lower die is situated a conveying platform having a cooling unit mounted right over the top side thereof, permitting the arched blind slat to keep moving forwards on the conveying platform precisely in the bent and curved form till dried and hardened by the cooling unit thereof to provide a fabricated arched blind slat. Therefore, the molding apparatus thereof can not only achieve an automatic processing of the curved blind slats, but also maintain a regular and even curvature of each blind slat fabricated thereby, efficiently boosting the delicacy and value of the blind slats thereof for more competitive power on the market.

### BACKGROUND OF THE INVENTION

The present invention is related to an apparatus for manufacturing blind slats, comprising a molding apparatus equipped with a heating unit to heat and soften a finished blind slat thereby wherein at one adjacent side of the heating unit is situated a set of lower and upper dies towards which the heated blind slat is continuously fed and moved forwards at matching curved convex and concave surfaces of the lower and upper dies there-between so as to press and bend the softened blind slat into an arched form thereby, and at the other side of the lower die is situated a conveying platform having a cooling unit mounted right over the top side thereof to dry and hardened the fabricated arched blind slat thereby; therefore, the molding apparatus thereof can not only achieve an automatic processing of the curved blind slats, but also maintain a regular and even curvature of each blind slat fabricated thereby, efficiently boosting the delicacy and value of the blind slats for more competitive power on the market.

Please refer to FIG. 1 showing a perspective view of a conventional bamboo blind slat. A conventional blind slat 10 as disclosed in FIG. 1 is made up of bamboo strips 11 that are closely arranged in juxtaposed manner and tightly bound together at binding sections 12 before further solidified in form via a layer of adhesive coating applied onto the binding sections 12 thereon to provide a finished bamboo blind slat 10 thereby, and the blind slat 10 obtained thereby is securely bound and fastened by the adhesive agent into a rigid and straight plate without any curvature fabricated for variation, which is rather monotonous in practical use. And, even if manually bent into a curved form, the arched blind slats 10 tend to come up with irregular and uneven curvature in the hand-made processing thereof, which can destroy the quality of the blind slats 10 and make them uncompetitive on the market.

### SUMMARY OF THE PRESENT INVENTION

It is, therefore, the primary purpose of the present invention to provide an apparatus for manufacturing blind slats, comprising a molding apparatus equipped with a heating unit to heat and soften a finished blind slat thereby wherein at one adjacent side of the heating unit is situated a set of lower and upper dies towards which the heated blind slat is continuously fed and moved forwards at matching curved convex and concave surfaces of the lower and upper dies there-between so as to press and bend the softened blind slat into an arched form thereby, and at the other side of the lower die is situated a conveying platform having a cooling unit mounted right over the top side thereof to dry and hardened the fabricated arched blind slat thereby; therefore, the molding apparatus thereof can not only achieve an automatic processing of the curved blind slats, but also maintain a regular and even curvature of each blind slat fabricated thereby, efficiently boosting the delicacy and value of the blind slats for more competitive power on the market.

### BRIEF DESCRIPTION OF THE DRAWINGS

FIG. 1 is a perspective view of a conventional blind slat.

FIG. 2 is an elevation diagram showing a blind slat moving forwards along a molding apparatus of the present invention.

FIG. 3 is a sectional diagram showing a blind slat processed between a set of upper and lower dies of the present invention.

FIG. 4 is a perspective view of an arched blind slat fabricated by the present invention.

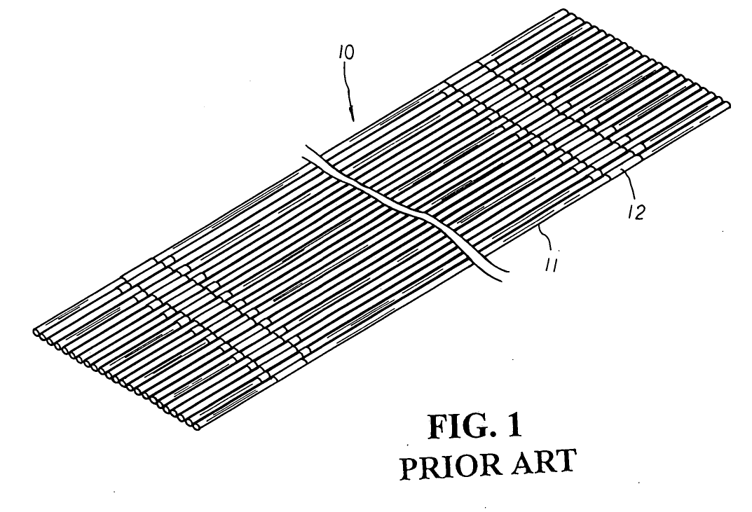

### DETAILED DESCRIPTION OF THE PREFERRED EMBODIMENTS

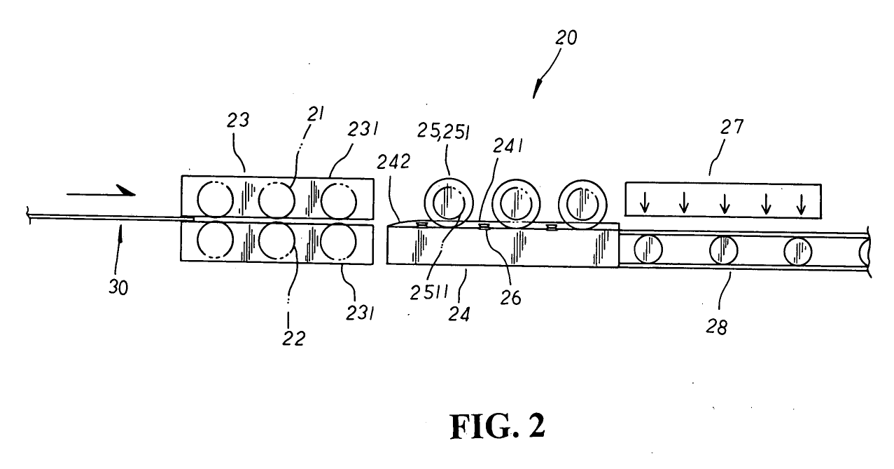

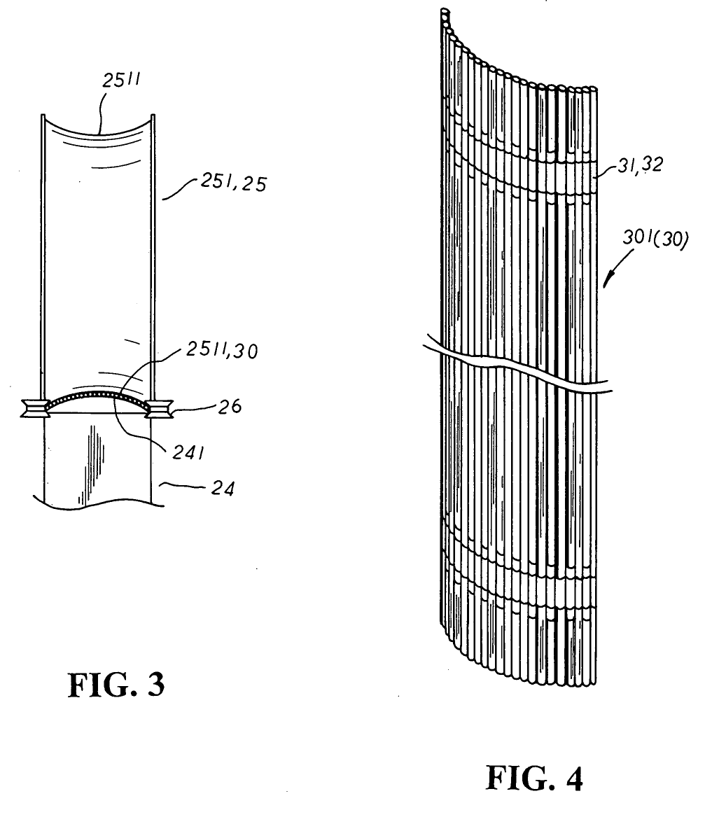

Please refer to FIGS. 2 to 4 inclusive. The present invention is related to an apparatus for manufacturing blind slats, comprising a molding apparatus 20 equipped with a multiplicity of upper and lower rollers 21, 22 applied to hold and feed a finished blind slat 30 towards a heating unit 23 having a set of upper and lower thermoelectric panels 231 to heat and soften binding sections 31 and adhesive coating 32 like acrylic glue of the finished blind slat 30 passing through the heating unit 23 thereof. At one adjacent side of the heating unit 23 is situated a lower die 24 having a curved convex surface 241 defined thereon as shown in FIG. 3, and a slant guide section 242 disposed at one end of the curved convex surface 241 for guiding the heated and softened blind slat 30 to move smoothly forwards along the convex surface 241 of the lower die 24 thereby. On top of the lower die 24 is disposed a multiplicity of upper dies 25 that, each made of a roller die 251 and defined by a curved concave surface 2511 thereon, are applied to roll and press onto the upper surface of the blind slat 30, permitting the blind slat 30 to precisely clamp at the convex surface 241 of the lower die 24 and the matching concave surfaces 2511 of the upper dies 25 there-between and, thus, bend into an arched form thereby. The lower die 24 also has a plurality of roller-like positioning stop members 26 arranged at both edges thereon, precisely abutting against and limiting both lateral edges of the arched blind slat 30 so as to prevent the blind slat 30 from going astray in the conveying process and coming up with an oblique and uneven curvature in the fabrication thereof. At the other side of the lower die 24 is situated a conveying platform 28 having a cooling unit 27 mounted right over the top side thereof. When the blind slat 30 gradually moves from the other end of the lower die 24 towards the conveying platform 28, one end of the blind slat 30 is still held in place by the lower and upper dies 24, 25 thereof, permitting the arched blind slat 30 to keep moving forwards on the conveying platform 28 precisely in the bent and curved form till dried and hardened by the cooling unit 27 to provide a fabricated arched blind slat 301 as shown in FIG. 4. Therefore, the molding apparatus 20 thereof can not only achieve an automatic processing of the curved blind slats 301, but can also maintain a regular and uniform curvature of each blind slat 301 fabricated thereby, efficiently boosting the delicacy and value of the blind slats thereof for more competitive power on the market.

What is claimed is:

1. An apparatus for manufacturing blind slats, comprising a molding apparatus equipped with a multiplicity of upper and lower rollers applied to hold and feed a finished blind slat towards a heating unit so that binding sections and adhesive coating of the blind slat can become softened thereby wherein at one adjacent side of the heating unit is situated a lower die having a curved convex surface defined thereon towards which the heated and softened blind slat is continuously moved along, and on top of the lower die is disposed a multiplicity of upper dies each having a curved concave surface defined thereon to roll and press onto the upper surface of the blind slat thereby, permitting the blind slat to precisely clamp at the matching curved convex and concave surfaces of the lower and upper dies there-between and, thus, bend into an arched form thereby while proceeding forwards there-through; the lower die also has a plurality of positioning stop members arranged at both edges thereon, precisely abutting against and limiting both lateral edges of the arched blind slat so as to prevent the blind slat from going astray in the conveying process and coming up with an oblique and uneven curvature in the fabrication thereof; at the other side of the lower die is situated a conveying platform having a cooling unit mounted right over the top side thereof wherein, when the blind slat gradually moves from the other end of the lower die towards the conveying platform, one end of the blind slat is still held in place by the upper and lower dies thereof, permitting the arched blind slat to keep moving forwards on the conveying platform precisely in the bent and curved form till dried and hardened by the cooling unit thereof to provide a fabricated arched blind slat thereby.

2. The apparatus for manufacturing blind slats according to claim 1 wherein the heating unit is preferably made up of a set of upper and lower thermoelectric panels.

3. The apparatus for manufacturing blind slats according to claim 1 wherein the curved convex surface of the lower die has a slant guide section defining one end thereon.

4. The apparatus for manufacturing blind slats according to claim 1 wherein the upper dies can be made of a plurality of roller dies.

5. The apparatus for manufacturing blind slats according to claim 1 wherein the positioning stop members arranged at both lateral edges of the lower die thereof are preferably shaped in roller-like forms.
